(19) United States
(12) Patent Application Publication
(10) Pub. No.: US 2010/0182900 A1
(43) Pub. Date: Jul. 22, 2010

(54) APPARATUS AND METHOD FOR REUSING BASE STATION IDENTIFIER IN A BROADBAND WIRELESS COMMUNICATION SYSTEM

(75) Inventors: Min-Ho Sung, Yongin-si (KR); Jun-Hwan Oh, Seongnam-si (KR); Han-Seok Kim, Seoul (KR); Min-Sik Ju, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/692,291

(22) Filed: Jan. 22, 2010

(30) Foreign Application Priority Data
Jan. 22, 2009 (KR) 10-2009-0005319

(51) Int. Cl. H04W 36/00; H04J 11/00

(52) U.S. Cl. 370/210; 370/331; 455/436

(57) ABSTRACT

Use of Base Station IDentifier (BSID) in a wireless communication system is provided. Operations of a control station which controls a Base Station (BS) includes, when receiving a handover request message that includes a special BSID allocated for reuse as a target BSID, from other control station, sending a handover response message to the other control station; when receiving a handover complete message from a lower BS, determining whether the lower BS uses the special BSID; and sending a handover complete message comprising the special BSID to the other control station.

### PRIORITY

The present application claims priority under 35 U.S.C. §119(a) to a Korean patent application filed in the Korean Intellectual Property Office on Jan. 22, 2009 and assigned Serial No. 10-2009-0005319, the entire disclosure of which is hereby incorporated by reference.

### BACKGROUND OF THE INVENTION

1. Field of the Invention

The present invention relates generally to a broadband wireless communication system, and more particularly, to an apparatus and a method for reusing a Base Station IDentifier (BSID) in the broadband wireless communication system.

2. Description of the Related Art

A fourth generation (4G) communication system, which is a next-generation communication system, aims to provide users with services of various Quality of Service (QoS) levels at a data rate of about 100 Mbps. Particularly, the 4G communication systems are advancing in order to support high-speed services by guarantying mobility and a QoS in Broadband Wireless Access (BWA) communication systems such as Wireless Local Area Network (WLAN) systems and Wireless Metropolitan Area Network (WMAN) systems. the 4G communication system is based on the Institute of Electrical and Electronics Engineers (IEEE) 802.16 standard.

An IEEE 802.16 system defines a neighbor list for fast handover. A base station includes a list of neighbor base stations and radio configuration information of the neighbor base stations in the neighbor list, and sends the neighbor list to terminals traveling in a cell using a MOBile_NeighBoR-ADVertisement (MOB_NBR-ADV) broadcast message. The terminals periodically measure the signal of the neighbor base stations and perform a fast handover using the measured signal.

According to the IEEE 802.16 standard, the number of Base Station IDentifiers (BSIDs) in the neighbor list is a maximum of 255. However, because of the limitation on the neighbor BS search performance of the terminals, the neighbor list includes only a maximum of 32 BSIDs are used. When 32 or more BSs are concentrated in the area, the handover is not carried out normally. This situation can frequently happen in city areas. For example, since a femto cell BS installed in every floor of the building is mostly a small low-power product, a plurality of the BSs is installed in a small area. When a plurality of buildings resides in one macro cell due to the femto cell BSs, the number of the neighbor BSs of the macro BS can exceed far more than 32. When the use of the home femto cell BS increases, the same situation may happen in a densely populated area such as apartment. In this respect, what is needed is a solution for overcoming the limited number of BSIDs in the neighbor list and for carrying out a smooth handover.

### SUMMARY OF THE INVENTION

An aspect of the present invention is to substantially solve at least the above problems and/or disadvantages and to provide at least the advantages below. Accordingly, an aspect of the present invention is to provide an apparatus and a method for overcoming the limited number of BSIDs of a neighbor list in a broadband wireless communication system.

Another aspect of the present invention is to provide an apparatus and a method for reusing a BSID in a broadband wireless communication system.

Yet another aspect of the present invention is to provide an apparatus and a method for performing handover of a terminal when a plurality of base stations use the same BSID in a broadband wireless communication system.

According to one aspect of the present invention, an operating method of a control station which controls a base station in a broadband wireless communication system includes, when receiving a handover request message that includes a special Base Station IDentifier (BSID) allocated for reuse as a target BSID, from other control station, sending a handover response message to the other control station; when receiving a handover complete message from a lower BS, determining whether the lower BS uses the special BSID; and sending a handover complete message comprising the special BSID to the other control station.

According to another aspect of the present invention, an operating method of an indoor base station in a broadband wireless communication system includes, when a transmission cycle of a preamble signal arrives, sending a preamble signal corresponding to a special BSID allocated for reuse; when a terminal requests an initial ranging procedure, performing the initial ranging procedure with the terminal using the special BSID; and after the initial ranging procedure, sending a handover complete message comprising a general BSID to an upper control station.

According to yet another aspect of the present invention, an apparatus of a control station which controls a base station in a broadband wireless communication system includes a backhaul communicator for, when receiving a handover request message that includes a special BSID allocated for reuse as a target BSID, from other control station, sending a handover response message to the other control station; and a controller for, when receiving a handover complete message from a lower BS, determining whether the lower BS uses the special BSID. The backhaul communicator sends a handover complete message that includes the special BSID to the other control station.

According to still another aspect of the present invention, an apparatus of an indoor base station in a broadband wireless communication system includes a sender for, when a transmission cycle of a preamble signal arrives, sending a preamble signal corresponding to a special BSID allocated for reuse; a controller for, when a terminal requests an initial ranging procedure, performing the initial ranging procedure with the terminal using the special BSID; and a backhaul communicator for, after the initial ranging procedure, sending a handover complete message comprising a general BSID to an upper control station.

According to a further aspect of the present invention, a broadband wireless communication system covering a macro cell and a femto cell includes a terminal for handing over from a first base station which is a lower base station of a first control station, to a second base station which is a lower base station of a second control station; and the base station for sending a preamble signal corresponding to a special BSID allocated for reuse according to a transmission cycle of the preamble signal, performing an initial ranging procedure with the terminal using the special BSID, and sending a handover complete message comprising a general BSID to the second control station.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain embodiments the present invention will become more apparent from the following detailed description taken in conjunction with the accompanying drawings, in which:

FIG. 1 illustrates cell configuration in a broadband wireless communication system according to an embodiment of the present invention;

FIG. 2 illustrates messages exchanged according to handover in the broadband wireless communication system according to an embodiment of the present invention;

FIG. 3 illustrates a control station in the broadband wireless communication system according to an embodiment of the present invention;

FIG. 4 illustrates an indoor base station in the broadband wireless communication system according to an embodiment of the present invention;

FIG. 5 illustrates operations of the control station in the broadband wireless communication system according to an embodiment of the present invention; and

FIG. 6 illustrates operations of the indoor base station in the broadband wireless communication system according to an embodiment of the present invention.

Throughout the drawings, like reference numerals will be understood to refer to like parts, components and structures.

### DETAILED DESCRIPTION OF EXEMPLARY EMBODIMENTS

Preferred embodiments of the present invention will be described herein below with reference to the accompanying drawings. In the following description, well-known functions or constructions are not described in detail since they would obscure the invention in unnecessary detail.

Embodiments of the present invention provide a technique for overcoming the limited number of Base Station IDentifiers (BSIDs) in a neighbor list and for carrying out a smooth handover. Hereinafter, an Orthogonal Frequency Division Multiplexing (OFDM)/Orthogonal Frequency Division Multiple Access (OFDMA) wireless communication system is explained by way of example. The present invention can be applied to other wireless communication systems.

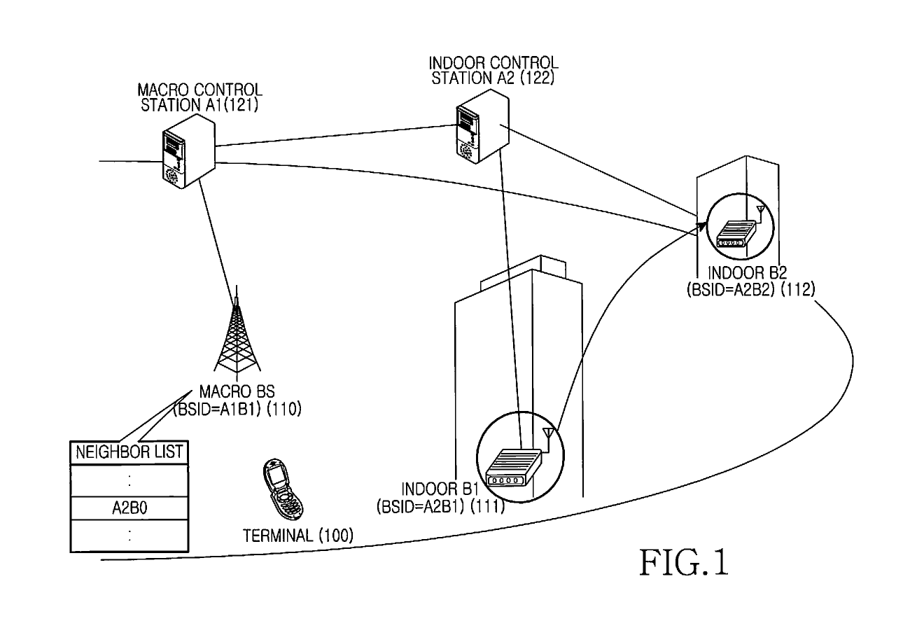

FIG. 1 depicts cell configuration in a broadband wireless communication system according to an embodiment of the present invention.

In FIG. 1, a terminal 100, which is mobile equipment of a user, can access a macro BS 110, an indoor BS B1 111, and an indoor BS B2 112 over radio channels. The macro BS 110, the indoor BS B1 111, and the indoor BS B2 112 provide radio connection to terminals in their cells, and encrypt traffic in the radio interval. Herein, the macro BS 110 manages a macro cell, and the indoor BS B1 111 and the indoor BS B2 112 manage femto cells and are installed indoors.

A macro control station A1 121 and an indoor control station A2 122 manage connection and mobility of terminals, and allocate service flows to the terminals on uplink and downlink basis. The macro control station A1 121 manages the terminals accessing to the macro BS 110 in charge of the macro cell. The indoor control station A2 122 manages the terminals accessing to the indoor BS B1 111 and the indoor BS B2 112 in charge of the femto cell. The BSID of the macro BS 110 is A1B1, the BSID of the indoor BS B1 111 is A2B1, and the BSID of the indoor BS B2 112 is A2B2 as shown in FIG. 1. Herein, the BSIDs includes the identification number of the upper control station in order to facilitate the understanding by explicitly representing the hierarchical relation of the BS and the control station. Naturally, other BSID configurations are contemplated, for example a BSID does not have to include the identification number of the upper control station, or some of the BSIDs of the BSs subordinate to the same control station may not match.

In the cell configuration of FIG. 1, the macro BS 110, the indoor BS B1 111, and the indoor BS B2 112 send a MOBile_NeighBoR-ADVertisement (MOB_NBR-ADV) message. The MOB_NBR-ADV message includes the BSIDs of the neighbor BSs. The neighbor BSs cover all of the macro BS and the indoor BSs. Hence, the terminal intending to hand over determines its target BS by scanning the neighbor BSs based on the BSIDs of the MOB_NBR-ADV message received from the serving BS.

In view of the macro BS 110, the indoor BS B1 111 and the indoor BS B2 112 installed in the building within the macro cell belong to the neighbor BSs. Accordingly, the MOB_NBR-ADV message of the macro BS 110 should include the BSID of the indoor BS B1 111 and the BSID of the indoor BS B2 112. However, the MOB_NBR-ADV message of the macro BS 110 includes A2B0 which is a special BSID allocated for reuse, instead of A2B1 which is the BSID of the indoor BS B1 111 and A2B2 which is the BSID of the indoor BS B2 112. The indoor BS B1 111 and the indoor BS B2 112 send a preamble signal corresponding to the special BSID of A2B0, rather than a preamble signal corresponding to their BSID. When the terminal 100 enters the cell coverage of the indoor BS B1 111 or the cell coverage of the indoor BS B2 112, the terminal 100 detects the preamble signal corresponding to the A2B0 and thus recognizes the accessibility to the indoor BS B1 111 or the indoor BS B2 112. That is, although the macro BS 110 identifies only one BSID with respect to the indoor BS B1 111 and the indoor BS B2 112, the terminal 100 can scan both of the indoor BS B1 111 and the indoor BS B2 112. Since the indoor BS B1 111 and the indoor BS B2 112 are installed in the different buildings, they do not interfere with each other when sending the same preamble signal. Notably, when the indoor BS B1 111 and the indoor BS B2 112 are installed on different floors in the same building and do not interfere with each other, they can use the same special BSID.

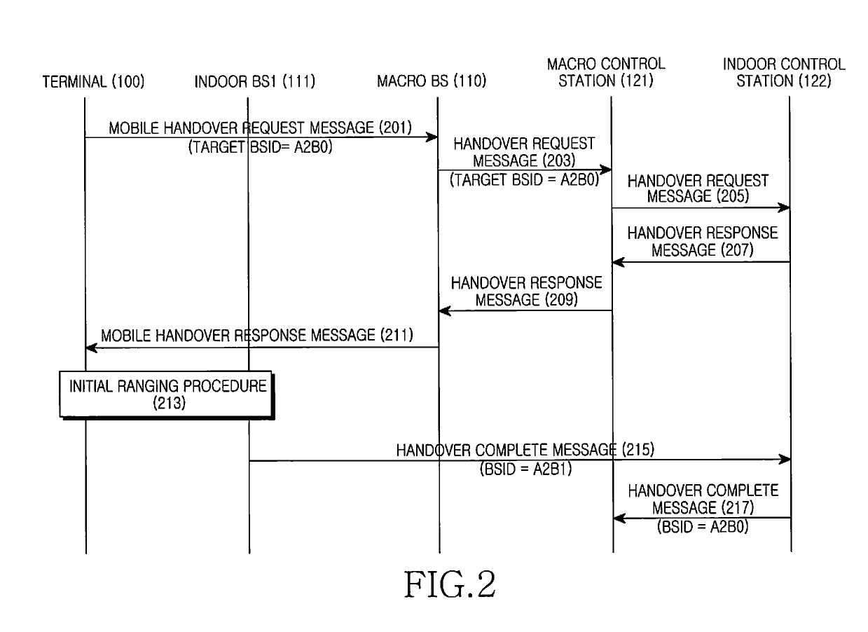

When the terminal 100 hands over from the macro BS 110 to the indoor BS B1 111, messages exchanged for the handover are shown in FIG. 2.

In FIG. 2, the terminal 100 scans based on the BSIDs of the MOB_NBR-ADV message of the macro BS 110, selects the BS of the BSID A2B0 as the target BS, and sends a mobile handover request message with the target BSID set to A2B0, to the macro BS 110 in step 201. Accordingly, the macro BS 110 sends a handover request message with the target BSID set to A2B0, to the macro control station 121 in step 203. The macro control station 121 sends a handover request message with the target BSID set to A2B0, to the indoor control station 122 in step 205.

Upon receiving the handover request message with the target BSID set to the special BSID, the indoor control station 122 sends a handover response message to the macro control station 121 in step 207, rather than sending the handover request message to the BS. The macro control station 121 sends a handover response message to the macro BS 110 in step 209. The macro BS 110 sends a mobile handover response message to the terminal 100 in step 211.

The terminal 100 receiving the mobile handover response message recognizes that the handover has been allowed and performs an initial ranging procedure with the indoor BS B1 111 in step 213. More specifically, the terminal 100 sends a ranging Code Division Multiple Access (CDMA) code, is allocated a resource for the initial ranging, exchanges a ranging message, and thus accesses the indoor BS B1 111. The ID of the BS used for the ranging message exchange is the special BSID A2B0. Next, the indoor BS B1 111 sends a handover complete message with the BSID set to A2B1, to the indoor control station 122 in step 215. The indoor control station 122 receiving the handover complete message recognizes that the terminal 100 accesses the indoor control station B1 111, and sends a handover complete message with the BSID set to A2B0, to the macro control station 121 in step 217. According to another embodiment of the present invention, the indoor control station 122 may send a handover complete message with the BSID set to A2B1, to the macro control station 121 in step 217.

In this embodiment explained in FIGS. 1 and 2, two indoor BSs are considered to ease the understanding. However, a specific BSID representing the BSIDs of three or more indoor BSs can be used, or a plurality of specific BSIDs can be used.

Now, structures and operations of the BS and the control station using the BSID as stated above will be described in further detail.

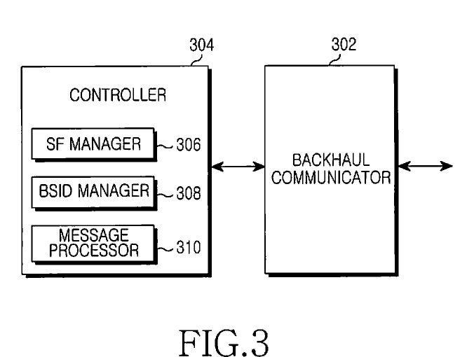

FIG. 3 is a block diagram of the control station in the broadband wireless communication system according to an embodiment of the present invention.

The control station of FIG. 3 includes a backhaul communicator 302 and a controller 304.

The backhaul communicator 302 provides an interface for communicating with lower BSs subordinate to the control station and other control stations. That is, the backhaul communicator 302 converts a bit string and a physical signal according to the standard of the backhaul network.

The controller 304 controls the functions of the control station. For example, the controller 304 provides transmit data to the backhaul communicator 302 and executes the function corresponding to data received through the backhaul communicator 302. A Service Flow (SF) manager 306 of the controller 304 allocates uplink SF and downlink SF to the terminals accessing the lower BSs, and controls the traffic flow according to the SF.

A BSID manager 308 of the controller 304 manages the BSIDs of the lower BSs. In particular, the BSID manager 308 manages at least one special BSID allocated for reuse. That is, the BSID manager 308 manages information indicating which lower BS uses the special BSID.

A message processor 310 confirms the type of the message and the information contained in the message by analyzing the messages received from the other control station and the lower BSs according to the defined form. The message processor 310 generates messages including the information to transmit to the other control station and the lower BSs. For instance, the message processor 310 analyzes the handover request message received from the other control station and the handover complete message received from the lower BS, and generates the handover response message and the handover complete message transmitted to the other control station.

More specifically, when receiving the handover request message including the target BSID as the special BSID from the other control station, the message processor 310 generates the handover response message, rather than the controller 304 sends the handover request message to the lower BS. The backhaul communicator 302 sends the handover response message to the other control station. Next, upon receiving the handover complete message from the lower BS, the controller 304 checks whether the lower BS is using the special BSID. When the lower BS uses the special BSID, the message processor 310 generates the handover complete message including the special BSID for the other control station and the backhaul communicator 302 sends the handover complete message to the other control station.

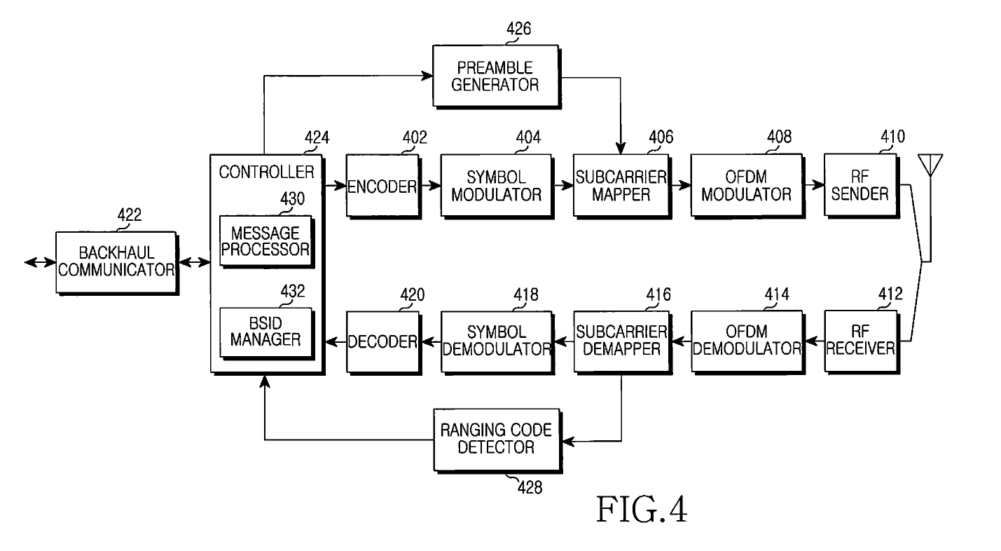

FIG. 4 is a block diagram of the indoor BS in the broadband wireless communication system according to an embodiment of the present invention.

The indoor BS of FIG. 4 includes an encoder 402, a symbol modulator 404, a subcarrier mapper 406, an OFDM modulator 408, a Radio Frequency (RF) sender 410, an RF receiver 412, an OFDM demodulator 414, a subcarrier demapper 416, a symbol demodulator 418, a decoder 420, a backhaul communicator 422, a controller 424, a preamble generator 426, and a ranging code detector 428.

The encoder 402 channel-codes the information bit string output from the controller 424. The symbol modulator 404 demodulates and converts the channel-coded bit string to complex symbols. The subcarrier mapper 406 maps the complex symbols into the frequency domain. The OFDM modulator 408 converts the complex symbols mapped to the frequency domain to a time-domain signal using an Inverse Fast Fourier Transform (IFFT) operation, and generates OFDM symbols by inserting a Cyclic Prefix (CP). The RF sender 410 up-converts the baseband signal to an RF band signal and transmits the RF band signal over an antenna.

The RF receiver 412 down-converts a downlink band signal received over the antenna to the baseband signal. The OFDM demodulator 414 divides the signal output from the RF receiver 412 to OFDM symbols, removes the CP, and recovers the complex symbols mapped to the frequency domain using FFT operation. The subcarrier demapper 416 classifies the complex symbols mapped to the frequency domain by the process unit. The symbol demodulator 418 demodulates and converts the complex symbols to the bit string. The decoder 420 restores the information bit string by channel-decoding the bit string.

The backhaul communicator 422 provides the interface for communicating with the upper control station. That is, the backhaul communicator 422 converts the bit string and the physical signal according to the standard of the backhaul network.

The controller 424 controls the functions of the indoor BS. A message processor 430 of the controller 424 confirms the type of the message and the information contained in the message by analyzing the messages received from the terminals and the upper control station according to the defined form. The message processor 430 generates messages including the information to send to the terminals and the upper control station. For example, the message processor 430 analyzes the ranging request message received from the terminals and generates the handover complete message transmitted to the upper control station and the ranging response message transmitted to the terminals. A BSID manager 432 of the controller 424 manages the BSIDs used by the indoor BS; that is, the general BSID and the special BSID. Herein, the special BSID is used to generate the preamble signal and to signal the terminal which enters through the handover. In more detail, the controller 424 provides the special BSID to the preamble generator 426. In the ranging procedure, with the terminal entering through the handover, the message processor 430 generates a message including the special BSID. 100431 The preamble generator 426 generates the preamble signal used to acquire the frame synchronization and to scan the BS, and outputs the preamble signal to the subcarrier mapper 406. The preamble generator 426 generates the preamble signal corresponding to the special BSID provided from the controller 424. The ranging code detector 428 detects the ranging CDMA code received from the terminal that requests the initial access, from the signal received in the ranging channel. Upon detecting the ranging CDMA code, the ranging code detector 428 informs the controller 424 of the detection of the ranging CDMA code.

In this embodiment, the blocks of FIG. 4 function as below. When the transmission cycle of the preamble signal arrives, the subcarrier mapper 406 maps the preamble signal to the corresponding radio resource and the RF sender 410 transmits the preamble signal. When the terminal requests the initial ranging procedure, that is, when the ranging code detector 428 detects the ranging CDMA code, the controller 424 performs the ranging procedure using the special BSID. In so doing, the message processor 430 includes the special BSID, as the ID of the BS, in the message transmitted for the initial ranging procedure. After the initial ranging procedure, the message processor 430 generates the handover complete message including the general BSID and the backhaul communicator 422 sends the handover complete message to the upper control station.

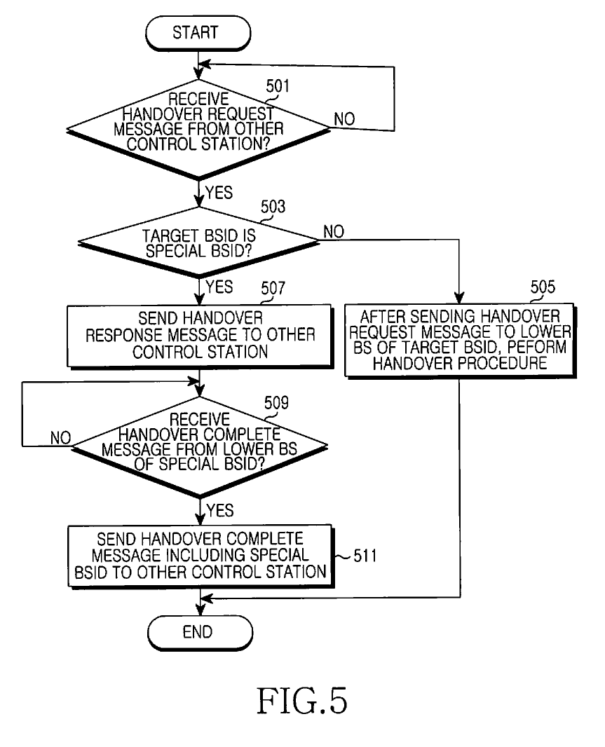

FIG. 5 illustrates operations of the control station in the broadband wireless communication system according to an embodiment of the present invention.

In step 501, the control station checks whether the handover request message is received from the other control station. That is, the control station checks whether the BS subordinate to the other control station requests the handover of the terminal to the BS subordinate to the control station. Herein, the handover request message includes the BSID of the target BS.

Upon receiving the handover request message, the control station examines whether the target BSID of the handover request message is the special BSID in step 503. That is, when receiving the handover request message, the control station compares at least one special BSID used by the lower BSs with the target BSID of the handover request message.

When the target BSID is not the special BSID, the control station sends the handover request message to the lower BS of the target BSID and then conducts the handover procedure in step 505.

By contrast, when the target BSID is the special BSID, the control station sends the handover response message to the other control station in step 507. Rather than sending the handover request message to the lower BS, the control station sends the handover response message to the other control station.

In step 509, the control station determines whether the handover complete message is received from the lower BS of the special BSID. Herein, the handover complete message includes the general BSID of the lower BS. That is, upon receiving the handover complete message, the control station checks whether the lower BS is using the special BSID.

When receiving the handover complete message from the lower BS of the special BSID, the control station sends the handover complete message including the special BSID to the other control station in step 511. In more detail, the control station recognizes the completion of the handover requested in step 501 by receiving the handover complete message from the lower BS of the special BSID, and sends the handover complete message indicating this to the other control station. According to another embodiment of the present invention, the control station may send a handover complete message with a general BSID for the lower BS to the other control station in step 511.

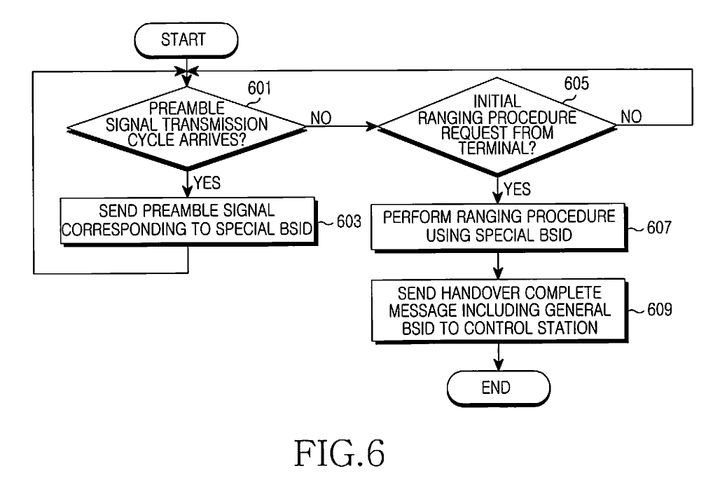

FIG. 6 illustrates operations of the indoor BS in the broadband wireless communication system according to an embodiment of the present invention.

In step 601, the indoor BS checks whether the transmission cycle of the preamble signal arrives. That is, the preamble signal is periodically transmitted.

When the transmission cycle of the preamble signal arrives, the indoor BS generates and transmits the preamble signal corresponding to the special BSID in step 603. The indoor BS manages the special BSID and the general BSID, and uses the special BSID to transmit the preamble signal.

When the transmission cycle of the preamble signal does not arrive, the indoor BS checks whether the initial ranging procedure is requested from the terminal in step 605. In other words, the indoor BS checks whether the ranging CDMA code is received from the terminal. The indoor BS determines whether the terminal intends to access the indoor BS.

When the initial ranging procedure is requested, the indoor BS performs the ranging procedure using the special BSID in step 607. The indoor BS manages the special BSID and the general BSID, and uses the special BSID for the ranging procedure. In further detail, the indoor BS carries out the ranging procedure by allocating the resource for the initial ranging to the terminal and exchanging the ranging messages. In so doing, the indoor BS includes the special BSID, as the ID of the BS, in the message transmitted for the ranging procedure.

In step 609, the indoor BS sends the handover complete message including the general BSID to the upper control station. The indoor BS manages the special BSID and the general BSID, and uses the general BSID to send the message to the upper control station. Hence, the indoor BS communicates with the terminal. The indoor BS and the terminal process the transmitted and received signals according to the OFDM scheme.

By reusing the BSID between the BSs in the broadband wireless communication system, the terminal can accomplish a smooth handover in an area where a plurality of BSs is concentrated.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An operating method of a control station which controls a Base Station (BS) in a wireless communication system, the method comprising the steps of:
when receiving, from another control station, a handover request message that includes a special Base Station IDentifier (BSID) allocated for reuse as a target BSID, sending, by the control station, a handover response message to the other control station;
when receiving a handover complete message from a lower BS, determining, by the control station, whether the lower BS uses the special BSID; and
sending, by the control station, a handover complete message comprising the special BSID to the other control station.

2. The method of claim 1, wherein the lower BS is an indoor BS which manages a femto cell.

3. An operating method of an indoor Base Station (BS) in a wireless communication system, the method comprising the steps of:
when a transmission cycle of a preamble signal arrives, transmitting, by the indoor BS, a preamble signal corresponding to a special Base Station IDentifier (BSID) allocated for reuse;
when a terminal requests an initial ranging procedure, performing, by the indoor BS, the initial ranging procedure with the terminal using the special BSID; and
after the initial ranging procedure, sending, by the indoor BS, to an upper control station a handover complete message comprising a general BSID.

4. The method of claim 3, wherein the performing of the initial ranging procedure with the terminal using the special BSID comprises:
including the special BSID, as an ID of the BS, in a message transmitted for the ranging procedure.

5. The method of claim 3, further comprising:
communicating, by the indoor BS, with the terminal according to an Orthogonal Frequency Division Multiplexing (OFDM) scheme.

6. An apparatus of a control station which controls a Base Station (BS) in a wireless communication system, the apparatus comprising:
a backhaul communicator for, when receiving a handover request message that includes a special Base Station IDentifier (BSID) allocated for reuse as a target BSID, from another control station, sending a handover response message to the other control station; and
a controller for, when receiving a handover complete message from a lower BS, determining whether the lower BS uses the special BSID,
wherein the backhaul communicator sends to the other control station a handover complete message that includes the special BSID.

7. The apparatus of claim 6, wherein the lower BS is an indoor BS which manages a femto cell.

8. An apparatus of an indoor Base Station (BS) in a wireless communication system, the apparatus comprising:
a transmitter for, when a transmission cycle of a preamble signal arrives, transmitting a preamble signal corresponding to a special Base Station IDentifier (BSID) allocated for reuse;
a controller for, when a terminal requests an initial ranging procedure, performing the initial ranging procedure with the terminal using the special BSID; and
a backhaul communicator for, after the initial ranging procedure, sending to an upper control station a handover complete message that includes a general BSID.

9. The apparatus of claim 8, wherein the controller includes the special BSID, as an ID of the BS, in a message transmitted for the ranging procedure.

10. The apparatus of claim 8, further comprising:
an Orthogonal Frequency Division Multiplexing (OFDM) modulator for conducting an Inverse Fast Fourier Transform (IFFT) operation on a signal transmitted to the terminal according to an OFDM scheme, and inserting a Cyclic Prefix (CP); and
an OFDM demodulator for removing the CP from a signal received from the terminal and conducting a Fast Fourier Transform (FFT) operation.

11. A wireless communication system covering a macro cell and a femto cell, comprising:
a terminal for handing over from a first base station which is a lower base station of a first control station, to a second base station which is a lower base station of a second control station; and
the first base station for sending a preamble signal corresponding to a special Base Station IDentifier (BSID) allocated for reuse according to a transmission cycle of the preamble signal, performing an initial ranging procedure with the terminal using the special BSID, and sending a handover complete message comprising a general BSID to the second control station.

12. The wireless communication system of claim 11, further comprising:
the first base station for, when receiving a mobile handover request message with a target BSID set to the special BSID from the terminal, sending to the first control station a handover request message with a target BSID set to the special BSID;
the first control station for sending to the second control station a handover request message with a target BSID set to the special BSID; and
the second control station for, when receiving the handover request message, sending a handover response message to the first control station.

13. The wireless communication system of claim 12, wherein the second control station, when receiving a handover complete message from a lower base station which uses the special BSID, sends to the first control station a handover complete message comprising the special BSID.

14. The wireless communication system of claim 13, wherein the first base station is a macro base station which manages the macro cell, and
the second base station is an indoor base station which manages the femto cell.

15. The wireless communication system of claim 13, wherein the first base station and the second base station communicate with the terminal according to an Orthogonal Frequency Division Multiplexing (OFDM) scheme.
